(19) United States
(12) Patent Application Publication
(10) Pub. No.: US 2023/0060890 A1
(43) Pub. Date: Mar. 2, 2023

(54) WIRELESS PROTOCOL FOR SENSING SYSTEMS

(71) Applicant: SENSATA TECHNOLOGIES, INC., ATTLEBORO, MA (US)

(72) Inventors: ARJANG AGAHI, TEMPLEPATRICK (IE); NICOLAS R. HENRIET, ARCON (FR); JONATHAN M. RIGELSFORD, SHEFFIELD (GB); GARY J. PARTIS, MORPETH (GB); STEPHEN C. MILLEN, COLERAINE (IE); JING DENG, BELFAST (GB); PHILIP S. CRAIG, BALLYMENA (IE); AARON P. DUIGNAN, CRAIGAVON (IE); PETER J. TASKER, TROWBRIDGE (GB)

(73) Assignee: SENSATA TECHNOLOGIES, INC., ATTLEBORO, MA (US)

(21) Appl. No.: 17/799,610

(22) PCT Filed: Jan. 22, 2021
(86) PCT No.: PCT/US2021/014492

§ 371 Date: Aug. 12, 2022

Related U.S. Application Data
(60) Provisional application No. 62/976,751, filed on Feb. 14, 2020.

(51) Int. Cl. H04W 56/00; H04B 1/7143; H04W 4/38

(52) U.S. Cl. CPC H04W 56/0015; H04B 1/7143; H04W 4/38

(57) ABSTRACT

A wireless protocol in a sensing system, including: sending, by a wireless network controller (WNC), to a plurality of wireless sensor nodes, based on a time division multiple access (TDMA), a synchronization message; and receiving, by the wireless network controller, based on the TDMA, first sensor data from each wireless sensor node of the plurality of wireless sensor nodes.

### TECHNICAL FIELD

The present disclosure relates to electronics. More particularly, this disclosure relates to a wireless protocol for sensing systems.

### BACKGROUND

Vehicles may use a variety of sensors to monitor the health and performance of various components. For example, sensors in an engine may be used to monitor the health of the engine. As another example, sensors coupled to batteries may be used to monitor the health and charge of the battery. In the case of electric vehicles that are powered by an array of battery cells, each cell or module of cells may have its own sensor. Thus, a vehicle may have multiple sensors needing to transmit sensor data for analysis.

### BRIEF DESCRIPTION OF DRAWINGS

FIG. 1 is a block diagram of an example sensing system utilizing a wireless protocol according to some embodiments.

FIG. 2 is a diagram of example time windows for data transmissions used for a wireless protocol for sensing systems according to some embodiments.

FIG. 3 is a diagram of an example byte encoding for data payloads for a wireless protocol for sensing systems according to some embodiments.

FIG. 4 is a flowchart of an example method for a wireless protocol for sensing systems according to some embodiments.

FIG. 5 is a flowchart of another example method for a wireless protocol for sensing systems according to some embodiments.

FIG. 6 is a flowchart of another example method for a wireless protocol for sensing systems according to some embodiments.

FIG. 7 is a flowchart of another example method for a wireless protocol for sensing systems according to some embodiments.

FIG. 8 is a flowchart of another example method for a wireless protocol for sensing systems according to some embodiments.

### SUMMARY OF INVENTION

In a particular embodiment, a method for utilizing a wireless protocol in a sensing system is disclosed that includes a wireless network controller (WNC) sending to a plurality of wireless sensor nodes, based on a time division multiple access (TDMA), a synchronization message. The method also includes the wireless network controller receiving, based on the TDMA, first sensor data from each wireless sensor node of the plurality of wireless sensor nodes.

In a particular embodiment, a sensing system that utilizes a wireless protocol is disclosed that includes a plurality of wireless sensor nodes and a wireless network controller (WNC). In the sensing system, the wireless network controller is configured to send to the plurality of wireless sensor nodes, based on a time division multiple access (TDMA), a synchronization message. The wireless network controller is also configured to receive, based on the TDMA, first sensor data from each wireless sensor node of the plurality of wireless sensor nodes.

As will be explained in greater detail below, the synchronization message may be used for network synchronization between the WNC and the wireless sensor nodes, so that each wireless sensor node provides sensor data to the wireless network controller in accordance with the correct TDMA. Because the wireless sensor nodes transmit and the wireless network controller receives sensor data based on TDMA, communication between the wireless network controller and the wireless sensor nodes is improved.

### DESCRIPTION OF EMBODIMENTS

The terminology used herein for the purpose of describing particular examples is not intended to be limiting for further examples. Whenever a singular form such as “a”, “an” and “the” is used and using only a single element is neither explicitly nor implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

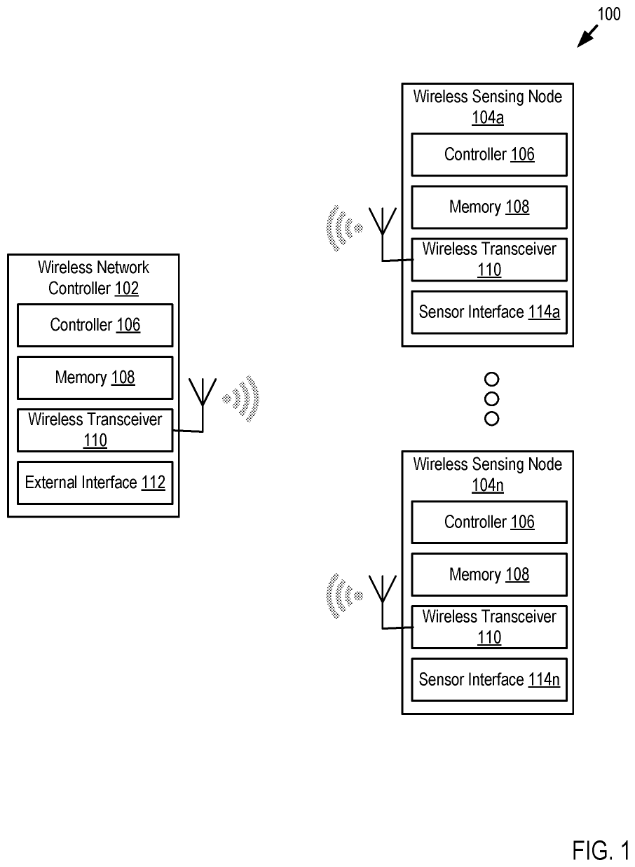

FIG. 1 is a block diagram of a non-limiting example sensing system 100 utilizing a wireless protocol. The example sensing system 100 may be deployed or implemented within a vehicle in various ways. For example, the sensing system 100 may be used in an electric vehicle powered by multiple battery modules. The sensing system 100 may then be used to receive sensor data from multiple sensors, each monitoring the health or charge of a battery module.

The sensing system 100 of FIG. 1 includes a wireless network controller (WNC) 102 and a plurality of wireless sensing nodes (WSN) 104a-n. The WNC 102 and WSNs 104a-n each include a respective controller 106. The controllers 106 may include or implement a microcontroller, an Application Specific Integrated Circuit (ASIC), a digital signal processor (DSP), a programmable logic array (PLA) such as a field programmable gate array (FPGA), or other data computation unit in accordance with the present disclosure. The WNC 102 and WSNs 104a-n also each include a respective memory 108. The memory 108 may include non-volatile memory to facilitate the processing of data transmitted between the WNC 102 and WSNs 104a-n.

The WNC 102 and WSNs 104a-n also each include a respective wireless transceiver 110. The wireless transceiver 110 includes a radio and/or antenna to facilitate transmissions between the WNC 102 and WSNs 104a-n. In some embodiments, the wireless transceivers 110 may include dual- or multi-channel radios to provide both hardware redundancy of radio and frequency channel diversity on the data link. Additional antennas (e.g., additional wireless transceivers 110) can be supported to provide more degrees of spatial diversity for improving the signal-to-noise ratio (SNR) of the link.

The WNC 102 includes an external interface 112 communicatively coupling the WNC 102 to an external device such as a vehicle control system or other external computing device. Each WSN 104a-n may include a sensor interface 114a-n. Each sensor interface 114a-n communicatively couples a WSN 104a-n to one or more external sensors (e.g., thermal sensors, light sensors, voltage or power systems, or any other sensor as can be appreciated). Alternatively, each WSN 104a-n may include the sensors themselves. Each WSN 104a-n may then generate and/or process sensor data based on measurements from their respective sensors.

The WNCs 102 and 104a-n are configured to communicate using a particular protocol. The protocol may be developed for energy efficient high reliability, low latency sensing systems including engine health monitoring for aerospace or nuclear applications, and battery monitoring in automotive and heavy vehicle off road (HVOR) markets. The protocol utilizes time division multiple access (TDMA) whereby messages are sent from the WNC 102 to the WSNs 104a-n. These SYNC messages are used for network synchronization and may provide network management functions such as frequency hopping information, and/or system specific commands. The WSNs 104a-n respond sequentially, each at its own time slot. For example, the SYNC message may indicate, to each of the WSNs 104a-n, a particular time slot for responding to the SYNC message or providing sensor data to the WNC 102. Each WSN 104a-n can correct its local system clock based on when it receives the SYNC message from the WNC 102.

In some embodiments, the WNC 102 implements a prescriptive hop, whereby all radio frequency channel hopping is controlled by the WNC 102. In some embodiments, the WNC 102 is configured to send, to each WSN 104a-n, the next few steps in the frequency hop sequence (FHS). The FHS enables simplified channel blacklisting (the mechanism of avoiding certain frequency channels due to poor performance or unwanted interference) as channels are simply omitted from the prescriptive hop sequence, and enables simple, reliable control of uniform, pseudo random, or random hop sequences. A benefit of the FHS to system performance is that each WSN 104a-n can continue to operate correctly and send its data to the WNC 102 for a period of time without receiving a SYNC message from the WNC, while maintaining frequency hopping and channel backlisting. This mechanism improves the reliability of the wireless link without decreasing the available network bandwidth necessary for sending retries of missed SYNC packets.

In some embodiments, the protocol can support counter with cipher block chaining message authentication code (CCM) or Galois/Counter Mode (GCM) encryption and cipher-based message authentication code (CMAC) generation utilizing Additional Authentication Data (AAD), with Elliptic-curve Diffie-Hellman (ECHD) key exchange. For example, FIG. 3 shows a table of various byte values in a payload from a WNC 102 or WSN 104a-n. In this example, the last eight bytes are used to encode a CCM or GCM CMAC. One skilled in the art will appreciate that the byte encodings of FIG. 3 are exemplary, and that other configurations may also be used and are contemplated within the scope of the present disclosure. In some embodiments, the system of FIG. 1 supports black-channel communication method enabling Automotive Safety Integrity Level D (ASIL-D) data using quadrature modulation (QM) radio components thereby reducing system cost.

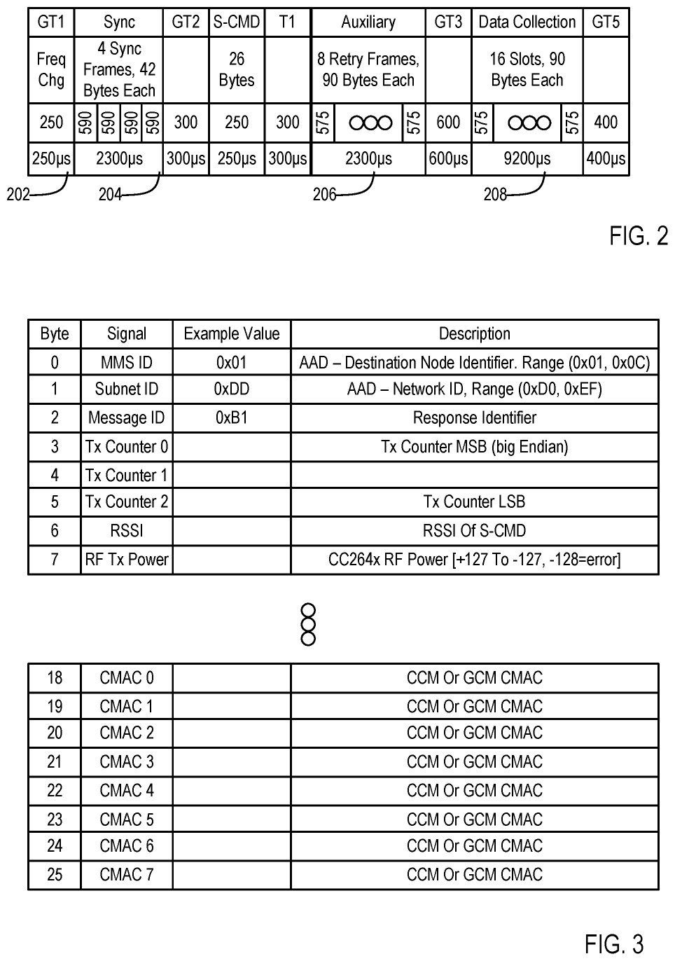

FIG. 2 shows an example table for data transmissions within the sensing system 100. For example, at a time window 202, a frequency change operation is performed where the WNC 102 and WSNs 104a-n each change their operational frequency for sending and receiving data to a particular frequency as determined by the FHS. At time window 204, the WNC 102 sends a SYNC message across four frames. At time window 206, the WNC 102 may send retry frames (e.g., retries of SYNC frames that were not received or confirmed). At time window 208, sensor data is received by the WNC 102 from WSNs 104a-n. Each WSN 104a-n is configured to transmit data to the WNC 102 during a particular slot of sixteen available slots. The particular slot used to transmit the data to the WNC 102 for a given WSN 104a-n may be specified in the initially received SYNC message. One skilled in the art will appreciate that the time windows described in FIG. 2 are exemplary, and that other configurations may also be used and are contemplated within the scope of the present disclosure.

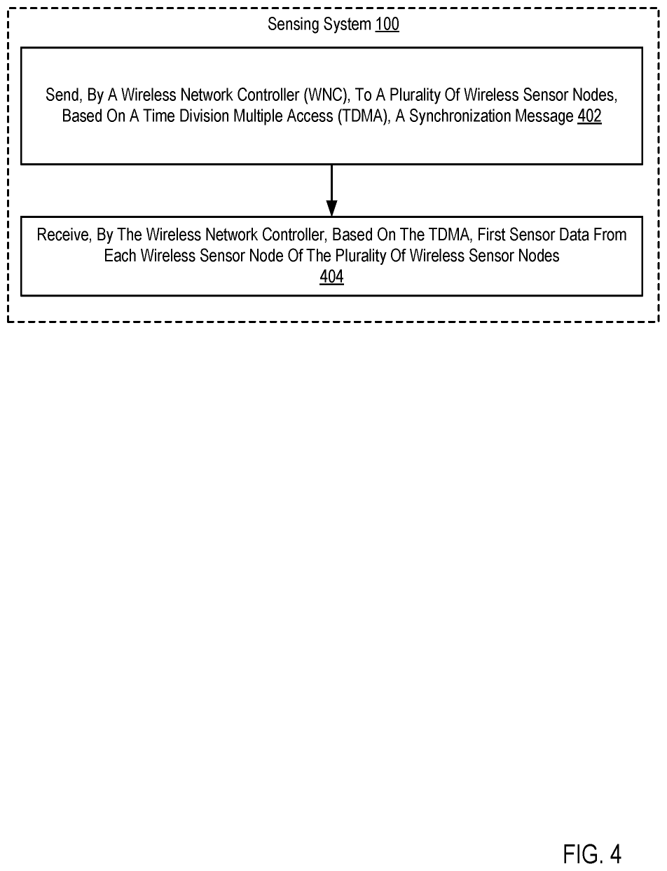

For further explanation, FIG. 4 sets forth a flowchart of an example method for a wireless protocol for sensing systems including sending 402, by a WNC 102, to a plurality of WSNs 104a-n, based on a Time Division Multiple Access (TDMA), a synchronization (SYNC) message. The TDMA may define a time window within a repeating cycle for sending the SYNC message. Accordingly, sending 402 the SYNC message includes sending the SYNC message in the defined time window.

In some embodiments, sending 402 the SYNC message includes sending 402 the SYNC message at a predetermined frequency. For example, where the SYNC message is the first SYNC message to be sent from the WNC 102 to the WSNs 104a-n, the WNC 102 may send the SYNC message at a predefined or default frequency, or a last used frequency. In some embodiments, the SYNC message is sent at a current frequency in a frequency hop sequence (FHS). For example, in some embodiments, a SYNC message will indicate, to the WSNs 104a-n, the FHS. After the WSNs 104a-n and WNC 102 change their operational frequencies to the next frequency in the FHS, a next sent SYNC message will be sent via the new operational frequency. In some embodiments, the SYNC message will indicate multiple frequencies in the FHS (e.g., N frequencies). Accordingly, in some embodiments, the SYNC message will only be sent after WSNs 104a-n and WNC 102 have changed to the last frequency in the FHS, or after having changed to some other defined index in the FHS (e.g., after having changed to the N−1^{st} frequency in the FHS).

In some embodiments, the SYNC message includes TDMA data indicating a particular time slot for each WSN 104a-n to send sensor data to the WNC 102. For example, assuming sixteen WSNs 104a-n, the SYNC message may indicate, for each WSN 104a-n, one of sixteen time slots for sending sensor data to the WNC 102. A time slot for sending sensor data to the WNC 102 is a subdivision of a time window for collecting sensor data by the WNC 102 (e.g., a time slot 208 of FIG. 2). One skilled in the art will appreciate that the number of time slots for sending sensor data by the WSNs 104a-n may vary and be configured based on a number of WSNs 104a-n. Moreover, one skilled in the art will appreciate that the sensing system 100 may be configured to implement a same number of time slots or more time slots than there are WSNs 104a-n. For example, the sensing system 100 may be configured to perform data collection across sixteen time slots, but may only use ten of the sixteen time slots if there are ten WSNs 104a-n.

The method of FIG. 4 also includes receiving 404, by the WNC 102, based on the TDMA, first sensor data from each WSN 104a-n of the plurality of WSNs 104a-n. The first sensor data includes data generated by the sensors included in or communicatively coupled to each WSN 104a-n. For example, the first sensor data may include engine health data, battery health data, and the like, for a component monitored by the respective WSN 104a-n. The WNC 102 may receive 404 the first sensor data from each WSN 104a-n according to an ordering specified in the TDMA data of the SYNC message. The received sensor data may then be provided to a computer or other system of the vehicle for analysis, reporting, and the like.

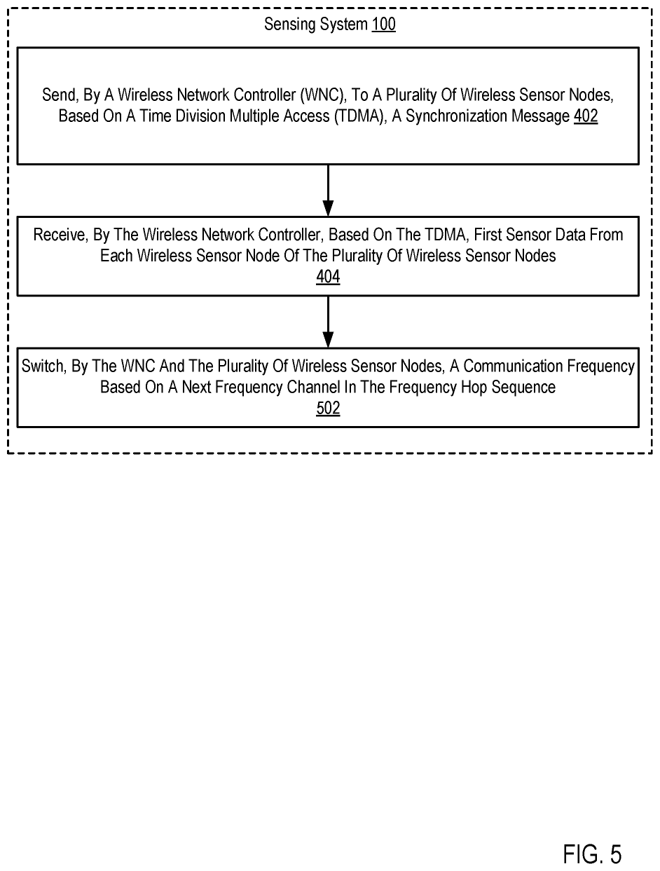

For further explanation, FIG. 5 sets forth a flowchart of another example method for a wireless protocol for sensing systems according to embodiments of the present disclosure. The method of FIG. 5 is similar to FIG. 4 in that the method of FIG. 5 includes sending 402, by a WNC 102, to a plurality of WSNs 104a-n, based on a Time Division Multiple Access (TDMA), a synchronization (SYNC) message; and receiving 404, by the WNC 102, based on the TDMA, first sensor data from each WSN 104a-n of the plurality of WSNs 104a-n.

FIG. 5 differs from FIG. 4 in that the method of FIG. 5 includes switching 502, by the WNC 102 and the plurality of WSNs 104a-n, a communication frequency based on a next frequency channel in the frequency hop sequence (FHS). Assume that the SYNC message indicated a plurality of frequency channels, and that the WNC 102 and the plurality of WSNs 104a-n are configured to switch their operational frequency based on the FHS according to some criteria (e.g., after performing N data collection cycles where sensor data is sent from the WSNs 104a-n to the WNC 102). After the criteria is satisfied, the WNC 102 and the plurality of WSNs 104a-n each switch their operational frequencies to the next indicated frequency channel in the FHS. Thus, sensor data subsequently sent by the WSNs 104a-n will be received by the WNC 102 via the changed frequency.

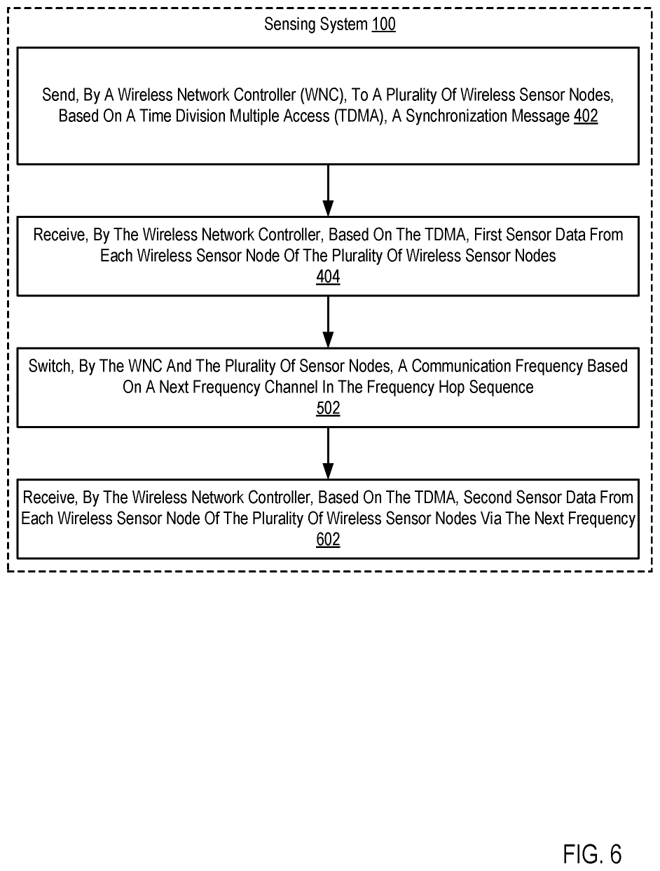

For further explanation, FIG. 6 sets forth a flowchart of another example method for a wireless protocol for sensing systems according to embodiments of the present disclosure. The method of FIG. 6 is similar to FIG. 5 in that the method of FIG. 6 includes sending 402, by a WNC 102, to a plurality of WSNs 104a-n, based on a Time Division Multiple Access (TDMA), a synchronization (SYNC) message; receiving 404, by the WNC 102, based on the TDMA, first sensor data from each WSN 104a-n of the plurality of WSNs 104a-n; and switching 502, by the WNC 102 and the plurality of WSNs 104a-n, a communication frequency based on a next frequency channel in the frequency hop sequence (FHS).

FIG. 6 differs from FIG. 4 in that the method of FIG. 6 includes receiving 602, by the WNC 102, based on the TDMA, second sensor data from each WSN 104a-n of the plurality of WSNs 104a-n. For example, the WNC 102 receives the second sensor data from each WSN 104a-n according to particular time slots indicated in TDMA data of a last sent SYNC message. Though the first sensor data was received after the SYNC message was sent by the WNC 102, the second sensor data is received over a different frequency without the need for another SYNC message to be sent WNC 102. As the SYNC message indicated multiple frequencies in the FHS, the WNC 102 and WSNs 104a-n can switch operational frequencies multiple times without sending another SYNC message.

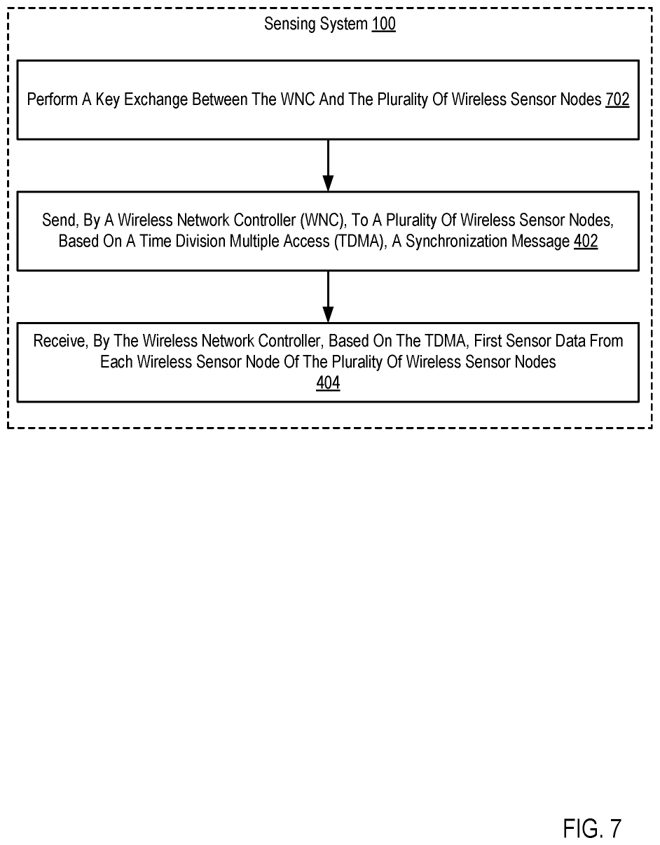

For further explanation, FIG. 7 sets forth a flowchart of another example method for a wireless protocol for sensing systems according to embodiments of the present disclosure. The method of FIG. 7 is similar to FIG. 4 in that the method of FIG. 7 includes sending 402, by a WNC 102, to a plurality of WSNs 104a-n, based on a Time Division Multiple Access (TDMA), a synchronization (SYNC) message; and receiving 404, by the WNC 102, based on the TDMA, first sensor data from each WSN 104a-n of the plurality of WSNs 104a-n.

FIG. 7 differs from FIG. 4 in that the method of FIG. 7 includes performing 702 a key exchange between the WNC 102 and the plurality of WSNs 104a-n. The key exchange may be performed using a predefined frequency, a last used frequency, or another frequency. The key exchange may include, as an example, an Elliptic-curve Diffie-Hellman (ECHD) key exchange or another key exchange as can be appreciated. For example, the key exchange may be performed using a frequency to send 402 the SYNC message from the WNC 102 to the plurality of WSNs 104a-n. The key exchange allows the WNC 102 and the plurality of WSNs 104a-n to each possess an encryption key for symmetric encryption, or encryption and decryption key pairs for use in asymmetric encryption. For example, in some embodiments, the SYNC messages sent by the WNC 102, sensor data received from the WSNs 104a-n, and other exchanged messages may be encrypted by a sender using an exchanged key. As another example, in some embodiments, the SYNC messages sent by the WNC 102, sensor data received from the WSNs 104a-n, and other exchanged messages may include message authentication codes generated based on an exchanged key. For example, the message authentication code may include a cipher block chaining message authentication code (CCM) or Galois/Counter Mode (GCM) encryption and cipher-based message authentication code (CMAC) generation utilizing Additional Authentication Data (AAD).

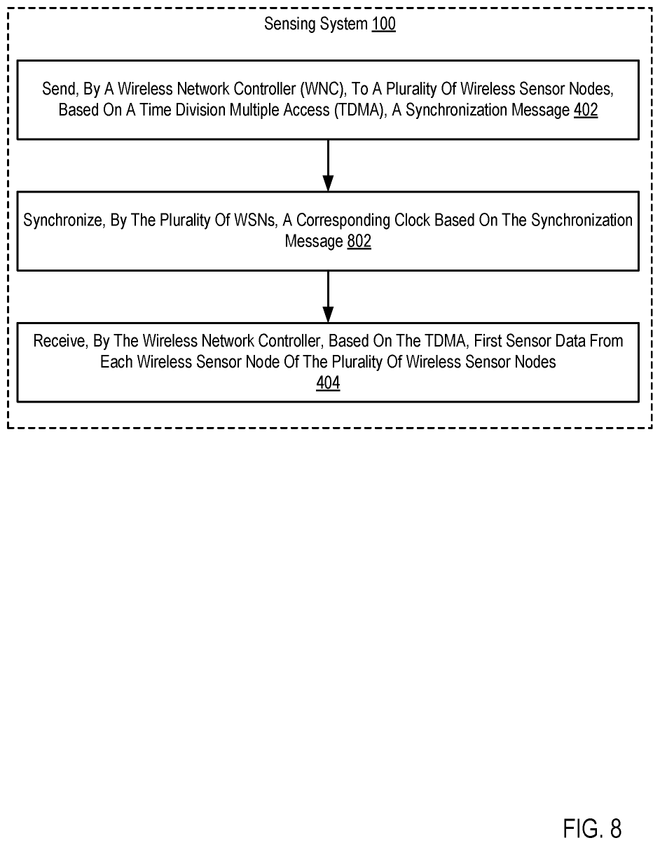

For further explanation, FIG. 8 sets forth a flowchart of another example method for a wireless protocol for sensing systems according to embodiments of the present disclosure. The method of FIG. 8 is similar to FIG. 4 in that the method of FIG. 8 includes sending 402, by a WNC 102, to a plurality of WSNs 104a-n, based on a Time Division Multiple Access (TDMA), a synchronization (SYNC) message; and receiving 404, by the WNC 102, based on the TDMA, first sensor data from each WSN 104a-n of the plurality of WSNs 104a-n.

FIG. 8 differs from FIG. 4 in that the method of FIG. 8 includes synchronizing 802, by the plurality of WSNs 104a-n, a corresponding clock based on the synchronization message. For example, assume that the SYNC message includes a time stamp generated by the WNC 102. The time stamp may indicate a time at which the SYNC message was generated or sent by the WNC 102. Further assume that each WSN 104a-n includes an internal clock. The internal clock of each WSN 104a-n may be referenced to determine when, in the TDMA, a given WSN 104a-n is to send its sensor data to the WNC 102. Each WSN 104a-n may synchronize their respective internal clock based on the time stamp included in the SYNC message. For example, each WSN 104a-n may set their internal clock to the time stamp, or to another value based on the time stamp (e.g., the time stamp incremented by some predefined value to reflect the transmission time between the WNC 102 and the WSNs 104a-n). As each WSN 104a-n synchronizes their respective clocks based on the same value included in the SYNC message, it ensures that each WSN 104a-n sends their respective sensor data during the correct time window as determined by the TDMA.

In view of the explanations set forth above, readers will recognize that the benefits of a wireless protocol for sensing systems include:
Improved reliability of a wireless data link and improved bandwidth efficiency by sending channel hop information as a prospective hop sequence.
Improved performance of wireless sensing system through hardware redundancy and frequency channel diversity of the data link.
Reduced cost using QM radio components while maintaining ASIL-D compliance.

Exemplary embodiments of the present disclosure are described largely in the context of a fully functional computer system utilizing a wireless protocol for sensing systems. Readers of skill in the art will recognize, however, that the present disclosure also can be embodied in a computer program product disposed upon computer readable storage media for use with any suitable data processing system. Such computer readable storage media can be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM) or Flash memory, a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Advantages and features of the present disclosure can be further described by the following statements:

1. A method, apparatus, system, computer program product, non-transitory medium for a wireless protocol in a sensing system, the method, apparatus, system, computer program product, non-transitory medium including sending, by a wireless network controller (WNC), to a plurality of wireless sensor nodes, based on a time division multiple access (TDMA), a synchronization message; and receiving, by the WNC, based on the TDMA, first sensor data from each wireless sensor node of the plurality of wireless sensor nodes.

2. The method, apparatus, system, computer program product, non-transitory medium of statement 1, wherein the synchronization message includes a frequency hop sequence indicating a plurality of frequency channels, and the method further comprises switching, by the WNC and the plurality of wireless sensor nodes, a communication frequency based on a next frequency channel in the frequency hop sequence.

3. The method, apparatus, system, computer program product, non-transitory medium of any of statements 1 and 2, wherein the frequency hop sequence comprises a random sequence, a pseudorandom sequence, or a uniform sequence.

4. The method, apparatus, system, computer program product, non-transitory medium of any of statements 1-3, further comprising receiving, by the WNC, based on the TDMA, second sensor data from each wireless sensor node of the plurality of wireless sensor nodes via the next frequency channel.

5. The method, apparatus, system, computer program product, non-transitory medium of any of statements 1-4, wherein the second sensor data is received without the WNC sending another synchronization message after switching the communication frequency.

6. The method, apparatus, system, computer program product, non-transitory medium of any of statements 1-5, further comprising synchronizing, by the plurality of wireless sensor nodes, a corresponding clock based on the synchronization message.

7. The method, apparatus, system, computer program product, non-transitory medium of any of statements 1-6, further comprising performing a key exchange between the WNC and the plurality of wireless sensor nodes.

8. The method, apparatus, system, computer program product, non-transitory medium of any of statements 1-7, wherein at least one of the synchronization message and the sensor data comprise one or message authentication codes based on an exchanged key.

9. The method, apparatus, system, computer program product, non-transitory medium of any of statements 1-8, wherein the key exchange comprises a Elliptic-curve Diffie-Hellman (ECHD) key exchange.

10. The method, apparatus, system, computer program product, non-transitory medium of any of statements 1-9, wherein the one or more message authentication codes comprise a cipher block chaining message authentication code (CCM) cipher-based message authentication code (CMAC).

11. A sensing system utilizing a wireless protocol, the sensing system comprising: a plurality of wireless sensor nodes; and a wireless network controller (WNC) configured to perform steps comprising: sending to the plurality of wireless sensor nodes, based on a time division multiple access (TDMA), a synchronization message; and receiving, based on the TDMA, first sensor data from each wireless sensor node of the plurality of wireless sensor nodes.

12. The sensing system of statement 11, wherein the synchronization message includes a frequency hop sequence indicating a plurality of frequency channels, and the steps further comprise switching, by the WNC and the plurality of wireless sensor nodes, a communication frequency based on a next frequency channel in the frequency hop sequence.

13. The sensing system of any of statements 11 and 12, wherein the frequency hop sequence comprises a random sequence, a pseudorandom sequence, or a uniform sequence.

14. The sensing system of any of statements 11-13, wherein the steps further comprise receiving, by the WNC, based on the TDMA, second sensor data from each wireless sensor node of the plurality of wireless sensor nodes via the next frequency channel.

15. The sensing system of any of statements 11-14, wherein the second sensor data is received without the WNC sending another synchronization message after switching the communication frequency.

16. The sensing system of any of statements 11-15, wherein the steps further comprise synchronizing, by the plurality of wireless sensor nodes, a corresponding clock based on the synchronization message.

17. The sensing system of any of statements 11-16, wherein the steps further comprise performing a key exchange between the WNC and the plurality of wireless sensor nodes.

18. The sensing system of any of statements 11-17, wherein at least one of the synchronization message and the sensor data comprise one or message authentication codes based on an exchanged key.

19. The sensing system of any of statements 11-18, wherein the key exchange comprises a Elliptic-curve Diffie-Hellman (ECHD) key exchange.

20. The sensing system of any of statements 11-19, wherein the one or more message authentication codes comprise a cipher block chaining message authentication code (CCM) cipher-based message authentication code (CMAC).

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

What is claimed is:

1. A method for a wireless protocol in a sensing system, the method comprising:
sending, by a wireless network controller (WNC), to a plurality of wireless sensor nodes, based on a time division multiple access (TDMA), a synchronization message; and
receiving, by the WNC, based on the TDMA, first sensor data from each wireless sensor node of the plurality of wireless sensor nodes.

2. The method of claim 1, wherein the synchronization message includes a frequency hop sequence indicating a plurality of frequency channels, and the method further comprises switching, by the WNC and the plurality of wireless sensor nodes, a communication frequency based on a next frequency channel in the frequency hop sequence.

3. The method of claim 2, wherein the frequency hop sequence comprises a random sequence, a pseudorandom sequence, or a uniform sequence.

4. The method of claim 2, further comprising receiving, by the WNC, based on the TDMA, second sensor data from each wireless sensor node of the plurality of wireless sensor nodes via the next frequency channel.

5. The method of claim 4, wherein the second sensor data is received without the WNC sending another synchronization message after switching the communication frequency.

6. The method of claim 1, further comprising synchronizing, by the plurality of wireless sensor nodes, a corresponding clock based on the synchronization message.

7. The method of claim 1, further comprising performing a key exchange between the WNC and the plurality of wireless sensor nodes.

8. The method of claim 1, wherein at least one of the synchronization message and the sensor data comprise one or message authentication codes based on an exchanged key.

9. The method of claim 7, wherein the key exchange comprises a Elliptic-curve Diffie-Hellman (ECHD) key exchange.

10. The method of claim 8, wherein the one or more message authentication codes comprise a cipher block chaining message authentication code (CCM) cipher-based message authentication code (CMAC).

11. A sensing system utilizing a wireless protocol, the sensing system comprising:
a plurality of wireless sensor nodes; and
a wireless network controller (WNC) configured to perform steps comprising:
sending to the plurality of wireless sensor nodes, based on a time division multiple access (TDMA), a synchronization message; and
receiving, based on the TDMA, first sensor data from each wireless sensor node of the plurality of wireless sensor nodes.

12. The sensing system of claim 11, wherein the synchronization message includes a frequency hop sequence indicating a plurality of frequency channels, and the steps further comprise switching, by the WNC and the plurality of wireless sensor nodes, a communication frequency based on a next frequency channel in the frequency hop sequence.

13. The sensing system of claim 12, wherein the frequency hop sequence comprises a random sequence, a pseudorandom sequence, or a uniform sequence.

14. The sensing system of claim 12, wherein the steps further comprise receiving, by the WNC, based on the TDMA, second sensor data from each wireless sensor node of the plurality of wireless sensor nodes via the next frequency channel.

15. The sensing system of claim 14, wherein the second sensor data is received without the WNC sending another synchronization message after switching the communication frequency.

16. The sensing system of claim 11, wherein the steps further comprise synchronizing, by the plurality of wireless sensor nodes, a corresponding clock based on the synchronization message.

17. The sensing system of claim 11, wherein the steps further comprise performing a key exchange between the WNC and the plurality of wireless sensor nodes.

18. The sensing system of claim 11, wherein at least one of the synchronization message and the sensor data comprise one or message authentication codes based on an exchanged key.

19. The sensing system of claim 17, wherein the key exchange comprises a Elliptic-curve Diffie-Hellman (ECHD) key exchange.

20. The sensing system of claim 18, wherein the one or more message authentication codes comprise a cipher block chaining message authentication code (CCM) cipher-based message authentication code (CMAC).
